(19) United States
(12) Patent Application Publication
(10) Pub. No.: US 2026/0200587 A1
(43) Pub. Date: Jul. 16, 2026

(54) AIRCRAFT PROPULSION SYSTEM WITH ACOUSTICALLY TREATED PROPULSOR ROTATING STRUCTURE

(71) Applicant: RTX Corporation, Farmington, CT (US)

(72) Inventors: Murat Yazici, Glastonbury, CT (US); Amr A. Ali, South Windsor, CT (US)

(21) Appl. No.: 19/016,708

(22) Filed: Jan. 10, 2025

(51) Int. Cl. B64D 33/02

(52) U.S. Cl. CPC B64D 33/02; B64D 2033/0206

(57) ABSTRACT

An apparatus is provided for an aircraft that includes a propulsion system. The propulsion system includes a propulsor rotor and an engine core configured to power rotation of the propulsor rotor about an axis. The propulsor rotor includes a plurality of propulsor blades and an outer platform. The propulsor blades are arranged circumferentially about the axis. Each of the propulsor blades projects radially out from the outer platform to a respective propulsor blade tip. The outer platform is configured with a platform acoustic treatment. The engine core includes a flowpath, a compressor section, a combustor section and a turbine section. The flowpath extends through the compressor section, the combustor section and the turbine section.

### BACKGROUND OF THE DISCLOSURE

### Technical Field

This disclosure relates generally to an aircraft and, more particularly, to a propulsion system for the aircraft.

### Background Information

Various types of propulsion systems for an aircraft are known in the art, including open and ducted rotor propulsion systems. While known aircraft propulsion systems have various benefits, there is still room in the art for improvement.

### SUMMARY OF THE DISCLOSURE

According to an aspect of the present disclosure, an apparatus is provided for an aircraft that includes a propulsion system. The propulsion system includes a propulsor rotor and an engine core configured to power rotation of the propulsor rotor about an axis. The propulsor rotor includes a plurality of propulsor blades and an outer platform. The propulsor blades are arranged circumferentially about the axis. Each of the propulsor blades projects radially out from the outer platform to a respective propulsor blade tip. The outer platform is configured with a platform acoustic treatment. The engine core includes a flowpath, a compressor section, a combustor section and a turbine section. The flowpath extends through the compressor section, the combustor section and the turbine section.

According to another aspect of the present disclosure, another apparatus is provided for an aircraft that includes a propulsion system. The propulsion system includes a propulsor rotating structure and an engine core configured to power rotation of the propulsor rotating structure about an axis. The propulsor rotating structure includes a propulsor rotor. The propulsor rotor includes a plurality of propulsor blades arranged circumferentially about the axis. The engine core includes a flowpath, a compressor section, a combustor section and a turbine section. The flowpath extends through the compressor section, the combustor section and the turbine section from an inlet into the flowpath to an exhaust from the flowpath. A flow boundary of the propulsion system is acoustically treated to attenuate sound generated by operation of the propulsion system along at least: an upstream section of the flow boundary that is upstream of the propulsor blades; and a downstream section of the flow boundary that is downstream of the propulsor blades and upstream of the inlet into the flowpath.

According to still another aspect of the present disclosure, another apparatus is provided for an aircraft that includes an open rotor propulsion system. The open rotor propulsion system includes a propulsor rotating structure and a turbine engine configured to drive rotation of the propulsor rotating structure about an axis. The propulsor rotating structure includes an open propulsor rotor. An exterior surface of a component of the propulsor rotating structure is exposed to and borders an environment external to the open rotor propulsion system. The component is configured with a component acoustic treatment extending axially and circumferentially along the exterior surface.

The component may be configured as or otherwise include an outer platform of the open propulsor rotor.

The propulsor rotating structure may also include a nose cone. The component may be configured as or otherwise include the nose cone.

An outer boundary wall axially between the open propulsor rotor and an inlet into the turbine engine may be configured with a wall acoustic treatment.

The open propulsor rotor may include a plurality of open propulsor blades arranged circumferentially about the axis. A first of the open propulsor blades may be configured with a blade acoustic treatment.

The propulsor rotating structure may also include a nose cone. The nose cone may at least partially form the upstream section of the flow boundary. In addition or alternatively, the propulsion system may also include an outer boundary wall axially between the propulsor rotor and the inlet into the flowpath. The outer boundary wall may at least partially form the downstream section of the flow boundary.

An outer platform of the propulsor rotor may also be acoustically treated to attenuate the sound generated by the operation of the propulsion system.

The flow boundary of the propulsion system may be acoustically treated using one or more cellular acoustic structures.

At least a portion of the platform acoustic treatment may be disposed between a circumferentially neighboring pair of the propulsor blades.

At least a portion of the platform acoustic treatment may extend circumferentially about the axis between and axially along the axis next to a circumferentially neighboring pair of the propulsor blades.

The propulsion system may also include a nose cone axially next to the propulsor rotor. The nose cone may be configured with a nose cone acoustic treatment.

The nose cone may be configured to rotate with the propulsor rotor about the axis.

The nose cone may be fixed to a stationary structure of the propulsion system.

A wall of the propulsion system may extend axially between the propulsor rotor and an inlet into the flowpath. The wall may be configured with a wall acoustic treatment.

A first of the propulsor blades may be configured with a blade acoustic treatment.

The propulsion system may also include an engine case housing the propulsor rotor.

The propulsion system may be configured as a turbofan propulsion system.

The propulsor rotor may be an open propulsor rotor. The outer platform may be exposed to and border an environment external to the propulsion system.

The propulsion system may be configured as an open rotor propulsion system.

The platform acoustic treatment may be configured as or otherwise include an acoustic panel with a cellular core.

The platform acoustic treatment may be configured as or otherwise include a single degree-of-freedom acoustic treatment.

The platform acoustic treatment may be configured as or otherwise include a multi degree-of-freedom acoustic treatment.

The present disclosure may include any one or more of the individual features disclosed above and/or below alone or in any combination thereof.

The foregoing features and the operation of the invention will become more apparent in light of the following description and the accompanying drawings.

### BRIEF DESCRIPTION OF THE DRAWINGS

FIG. 1 is a schematic illustration of a propulsion system with an open propulsor rotor configuration.

FIG. 2 is a schematic illustration of a portion of the propulsion system at a propulsion section.

FIG. 3 is a schematic cross-sectional illustration of a portion of an open propulsor rotor.

FIG. 4 is a schematic sectional illustration of a portion of a component configured with a single degree-of-freedom acoustic treatment.

FIGS. 5A and 5B are plan view illustrations of a portion of a cellular core with various sidewall arrangements.

FIG. 6 is a schematic sectional illustration of a portion of the component and the acoustic treatment of FIG. 4 during sound attenuation.

FIG. 7 is a schematic sectional illustration of a portion of the component configured with a double degree-of-freedom acoustic treatment.

FIG. 8 is a schematic cross-sectional illustration of a portion of the component with the acoustic treatment.

FIG. 9 is a partial schematic illustration of the propulsion system with a ducted propulsor rotor configuration.

### DETAILED DESCRIPTION

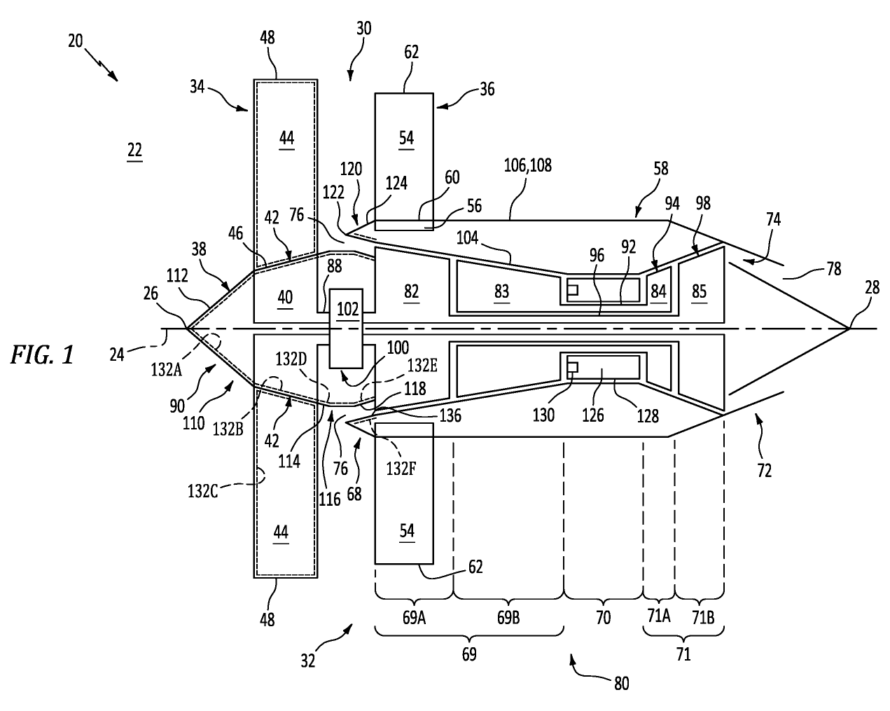

FIG. 1 is a schematic illustration of a propulsion system 20 for an aircraft. The aircraft may be an airplane, a drone (e.g., an unmanned aerial vehicle (UAV)), or any other manned or unmanned aerial vehicle or system. The aircraft propulsion system 20 may be configured as an open rotor propulsion system with a single open rotor and swirl recovery vane (SRV) architecture. Herein, the term “open” may describe a propulsion system section and/or a propulsion system component which is open to an environment 22 (e.g., an ambient environment) external to the aircraft propulsion system 20 and, more generally, the aircraft. The present disclosure, however, is not limited to such an exemplary aircraft propulsion system as described below in further detail.

The aircraft propulsion system 20 extends axially along an axis 24 between an upstream, forward end 26 of the aircraft propulsion system 20 and a downstream, aft end 28 of the aircraft propulsion system 20. The propulsion system axis 24 may be a centerline axis of the aircraft propulsion system 20 and/or a centerline axis of one or more members of the aircraft propulsion system 20. The propulsion system axis 24 may also or alternatively be a rotational axis of one or more members of the aircraft propulsion system 20. The aircraft propulsion system 20 of FIG. 1 includes an open rotor propulsion section 30 (e.g., an open rotor propulsion module) and a gas turbine engine 32.

The propulsion section 30 of FIG. 1 includes an open propulsor rotor 34 and an open guide vane structure 36. These propulsion section members 34 and 36 are un-ducted components of the aircraft propulsion system 20 and its propulsion section 30. The propulsion section 30 of FIG. 1 also includes a nose cone 38 disposed at (e.g., on, adjacent or proximate) the propulsion system forward end 26. Briefly, this nose cone 38 may be configured as a spinner which is rotatable with the propulsor rotor 34 about the propulsion system axis 24. Alternatively, the nose cone 38 may be configured as a stationary structure of the propulsion section 30, where the nose cone 38 is fixedly connected to another stationary structure of the aircraft propulsion system 20.

The propulsor rotor 34 includes a rotor base 40 (e.g., a disk or a hub), an outer platform 42 and a plurality of open propulsor blades 44 (e.g., airfoils). The propulsor blades 44 are arranged and may be equispaced circumferentially about the rotor base 40 and the propulsion system axis 24 in an array (e.g., a circular array), which array of propulsor blades may be unshrouded or alternatively shrouded by a tubular propulsor rotor shroud dedicated to the propulsor rotor 34 for example. Each of the propulsor blades 44 is connected to (e.g., formed integral with or otherwise attached to) the rotor base 40. Each of the propulsor blades 44 projects spanwise along a span line of the respective propulsor blade 44 (e.g., radially relative to the propulsion system axis 24) out from an exterior surface 46 of the outer platform 42, into the external environment 22, to a distal tip 48 of the respective propulsor blade 44. Each propulsor blade 44 is thereby configured as an un-ducted propulsor blade which is exposed to (e.g., disposed in) the surrounding external environment 22. Briefly, the outer platform 42 may be configured as a tubular body with apertures through which the propulsor blades 44 (or mounting couplings for the propulsor blades 44) respectively project radially through. Alternatively, the outer platform 42 may be configured from a plurality of discrete platform sections arranged circumferentially about the propulsion system axis 24. Each of the platform sections may be configured as a fairing member which is discrete from the propulsor blades 44 and mechanically attached or otherwise connected to the rotor base 40. Still alternatively, each of the platform sections may be configured integral with a respective one of the propulsor blades 44. The present disclosure, however, is not limited to such exemplary outer platform configurations.

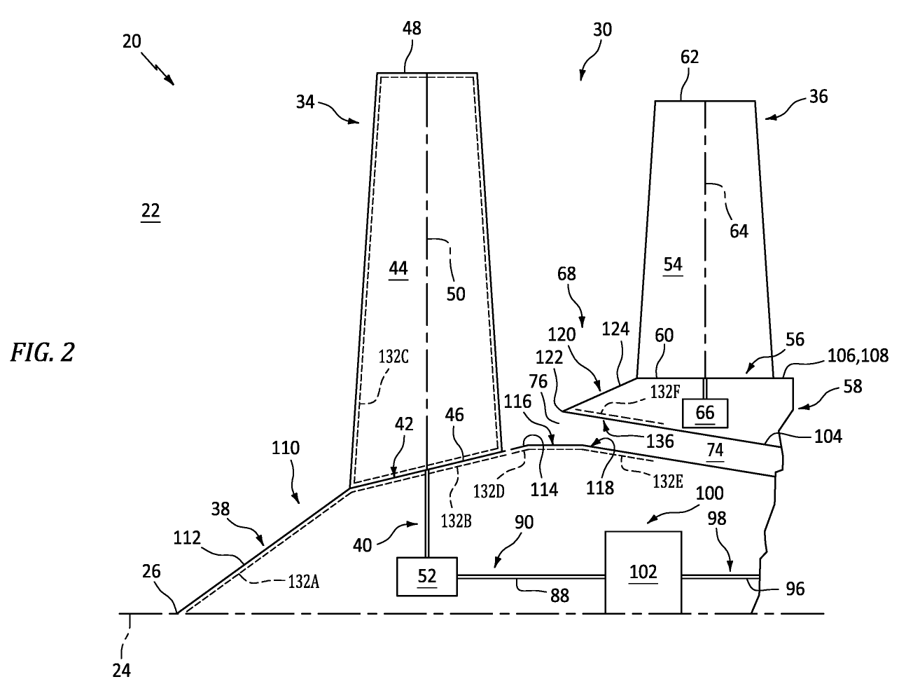

Referring to FIG. 2, each propulsor blade 44 may be configured to pivot about a respective blade pivot axis 50. This blade pivot axis 50 extends radially relative to the propulsion system axis 24. Each propulsor blade 44 of FIG. 2 is operatively coupled with a blade actuation system 52. This blade actuation system 52 is configured to pivot each propulsor blade 44 about its own respective blade pivot axis 50. By pivoting each propulsor blade 44 about its blade pivot axis 50, a pitch of the respective propulsor blade 44 may be changed. Of course, it is contemplated some or all of the propulsor blades 44 may be alternatively moved to change the propulsor blade pitch. Moreover, it is contemplated some or all of the propulsor blades 44 may alternatively be fixed pitch propulsor blades in other embodiments.

The guide vane structure 36 of FIG. 1 includes a plurality of open exit guide vanes 54 (e.g., airfoils) that are arranged and may be equispaced circumferentially about the propulsion system axis 24 in an array (e.g., a circular array), which array of guide vanes may be unshrouded or alternatively shrouded by a tubular guide vane shroud dedicated to the guide vane structure 36 for example. The guide vane structure 36 and its guide vanes 54 are arranged axially next to (e.g., adjacent) the propulsor rotor 34 and its propulsor blades 44. The guide vane structure 36 and its guide vanes 54 of FIG. 1, for example, are arranged downstream of the propulsor rotor 34 and its propulsor blades 44, without (e.g., any) other elements axially therebetween to obstruct, turn and/or otherwise influence the air propelled by the propulsor rotor 34 to the guide vane structure 36 for example. Each of the guide vanes 54 of FIG. 1 is coupled to a support structure 56 of a stationary housing structure 58 for the aircraft propulsion system 20. This support structure 56 may be configured as or otherwise include a support frame, a case and/or another fixed structure of the housing structure 58. Each of the guide vanes 54 projects spanwise along a span line of the respective guide vane 54 (e.g., radially relative to the propulsion system axis 24) out from an exterior surface 60 of the housing structure 58, into the external environment 22, to a distal tip 62 of the respective guide vane 54. Here, the exterior surface 60 radially borders the external environment 22 and forms an exterior aerodynamic flow surface of the aircraft propulsion system 20. Each guide vane 54 is thereby configured as an un-ducted guide vane which is exposed to (e.g., disposed in) the surrounding external environment 22.

Referring to FIG. 2, each guide vane 54 may be configured to pivot about a respective vane pivot axis 64. This vane pivot axis 64 extends radially relative to the propulsion system axis 24. Each guide vane 54 of FIG. 2 is operatively coupled with a vane actuation system 66, which vane actuation system 66 may be discrete from or integrated as part of the blade actuation system 52. The vane actuation system 66 is configured to pivot each guide vane 54 about its own respective vane pivot axis 64. By pivoting each guide vane 54 about its vane pivot axis 64, a pitch of the respective guide vane 54 may be changed. Of course, it is contemplated some or all of the guide vanes 54 may be alternatively moved to change the guide vane pitch. Moreover, it is contemplated some or all of the guide vanes 54 may alternatively be fixed pitch guide vanes in other embodiments.

Referring to FIG. 1, the turbine engine 32 includes an inlet section 68, a compressor section 69, a combustor section 70, a turbine section 71 and an exhaust section 72. The compressor section 69 of FIG. 1 includes a low pressure compressor (LPC) section 69A and a high pressure compressor (HPC) section 69B. The turbine section 71 of FIG. 1 includes a high pressure turbine (HPT) section 71A and a low pressure turbine (LPT) section 71B. The turbine engine 32 also includes an engine flowpath 74 (e.g., an annular core flowpath) which extends longitudinally through the aircraft propulsion system 20 of FIG. 1 and its turbine engine 32 from an airflow inlet 76 into the engine flowpath 74 to a combustion products exhaust 78 from the engine flowpath 74. The flowpath inlet 76 is also an airflow inlet into the aircraft propulsion system 20 of FIG. 1 and its turbine engine 32. The flowpath exhaust 78 is also a combustion products exhaust from the aircraft propulsion system 20 of FIG. 1 and its turbine engine 32. At least (or only) the LPC section 69A, the HPC section 69B, the combustor section 70, the HPT section 71A and the LPT section 71B collectively form a core 80 (e.g., a gas generator) of the turbine engine 32.

Each of the engine sections 69A, 69B, 71A and 71B includes a respective bladed rotor 82-85; e.g., a ducted engine rotor. Each of these engine rotors 82-85 includes a rotor base (e.g., a disk or a hub) and a plurality of rotor blades (e.g., airfoils, vanes, etc.). The rotor blades are arranged and may be equispaced circumferentially around the respective rotor base in an array. The rotor blades may also be arranged into one or more stages longitudinally along the engine flowpath 74. Each of the rotor blades is connected to the respective rotor base. Each of the rotor blades projects radially (e.g., spanwise) out from the respective rotor base into the engine flowpath 74 and to a distal tip of the respective rotor blade.

The propulsor rotor 34 is connected to and rotatable with a propulsor shaft 88. At least (or only) the propulsor rotor 34, the propulsor shaft 88 and (optionally) the nose cone 38 collectively form a propulsor rotating structure 90. This propulsor rotating structure 90 and its members 34, 38 and 88 are rotatable about the propulsion system axis 24.

The HPC rotor 83 is coupled to and rotatable with the HPT rotor 84. The HPC rotor 83 of FIG. 1, for example, is connected to the HPT rotor 84 by a high speed shaft 92. At least (or only) the HPC rotor 83, the HPT rotor 84 and the high speed shaft 92 collectively form a high speed rotating structure 94; e.g., a high speed spool of the turbine engine 32 and its engine core 80. This high speed rotating structure 94 of FIG. 1 and its members 83, 84 and 92 are rotatable about the propulsion system axis 24. However, in other embodiments, the high speed rotating structure 94 and its members 83, 84 and 92 may alternatively be rotatable about another rotational axis which is (e.g., laterally and/or angularly) offset from the rotational axis of the propulsor rotor 34.

The LPC rotor 82 is coupled to and rotatable with the LPT rotor 85. The LPC rotor 82 of FIG. 1, for example, is connected to the LPT rotor 85 by a low speed shaft 96. At least (or only) the LPC rotor 82, the LPT rotor 85 and the low speed shaft 96 collectively form a low speed rotating structure 98; e.g., a low speed spool of the turbine engine 32 and its engine core 80. This low speed rotating structure 98 of FIG. 1 and its members 82, 85 and 96 are rotatable about the propulsion system axis 24. However, in other embodiments, the low speed rotating structure 98 and its members 82, 85 and 96 may alternatively be rotatable about another rotational axis which is (e.g., laterally and/or angularly) offset from the rotational axis of the propulsor rotor 34.

The low speed rotating structure 98 is coupled to the propulsor rotating structure 90 and its propulsor rotor 34 through a drivetrain 100. This drivetrain 100 may be configured as a geared drivetrain, where a geartrain 102 (e.g., a transmission, a speed change device, an epicyclic geartrain, etc.) is disposed between and operatively couples the propulsor rotating structure 90 and its propulsor rotor 34 to the low speed rotating structure 98 and its LPT rotor 85. With this arrangement, the propulsor rotating structure 90 and its propulsor rotor 34 may rotate at a different (e.g., slower) rotational speed than the low speed rotating structure 98 and its LPT rotor 85. Here, the propulsor rotor 34 and the LPT rotor 85 may rotate in a common (the same) direction about the propulsion system axis 24 or in opposite directions about the propulsion system axis 24 depending, for example, upon the specific configuration of the geartrain 102. Alternatively, the drivetrain 100 may be configured as a direct-drive drivetrain, where the geartrain 102 is omitted. With such an arrangement, the propulsor rotating structure 90 and its propulsor rotor 34 rotate at a common (the same) rotational speed as the low speed rotating structure 98 and its LPT rotor 85.

The engine sections 68-72 may be arranged sequentially along the propulsion system axis 24 and are housed within and/or formed by the housing structure 58. This housing structure 58 includes an engine case 104 (e.g., a gas generator case) and a nacelle 106. The engine case 104 houses one or more of the engine sections 69A-71B; e.g., the engine core 80. The engine case 104 of FIG. 1, for example, extends axially along (e.g., axially overlaps) and extends circumferentially about (e.g., circumscribes) the engine sections 69A-71B and the bladed rotors 82-85. The engine case 104 may also house at least a portion of the drivetrain 100 and its geartrain 102. The nacelle 106 houses and provides an aerodynamic cover over the engine case 104. An exterior wall 108 of the nacelle 106 of FIG. 1, for example, is disposed radially outboard of, extends axially along (e.g., axially overlaps) and extends circumferentially about (e.g., circumscribes) the engine core 80 and its engine case 104. This nacelle wall 108 may at least partially or completely form the exterior surface 60. With the foregoing arrangement, the bladed rotors 82-85 are disposed within the housing structure 58. By contrast, the nose cone 38, the propulsor rotor 34 and the guide vane structure 36 are disposed at least partially (or completely) outside of the housing structure 58 within the external environment 22.

As external flow boundary 110 of the aircraft propulsion system 20 is located forward and upstream of the engine core 80 and the flowpath inlet 76. The propulsion system flow boundary 110 of FIG. 1, for example, extends axially along the propulsion system axis 24 from a forward, upstream boundary end to an aft, downstream boundary end. The upstream boundary end of FIG. 1 is located at the propulsion system forward end 26 and, more particularly, at a forward, upstream tip of the nose cone 38. The downstream boundary end of FIG. 1 is located at a radial inner side of the flowpath inlet 76. With this arrangement, the propulsion system flow boundary 110 may extend axially along and may be formed by at least (or only) an exterior surface 112 of the nose cone 38, the exterior surface 46 of the outer platform 42 and an exterior surface 114 of an outer boundary wall 116. Here, the outer boundary wall 116 extends axially along the propulsion system axis 24 from (or about) an aft, downstream end of the outer platform 42 to (or about) the inner side of the flowpath inlet 76. This outer boundary wall 116 may be a stationary component of the aircraft propulsion system 20. The outer boundary wall 116, for example, may be fixedly connected to or may be formed integral with (e.g., as an extension of) an inner flowpath wall 118 forming a radial inner peripheral boundary of the engine flowpath 74 at least at the flowpath inlet 76. The outer boundary wall 116 may alternatively be a rotating component of the aircraft propulsion system 20. The outer boundary wall 116, for example, may be fixedly connected to or may be formed as integral with (e.g., as an extension of) the outer platform 42.

During operation of the aircraft propulsion system 20 of FIG. 1, ambient air within the external environment 22 flows along the propulsion system flow boundary 110 and is propelled by the rotating propulsor rotor 34 in the downstream, aft direction towards the propulsion system aft end 28. A major portion (e.g., more than 50%) of this air bypasses the engine core 80 to provide forward thrust while a minor portion (e.g., less than 50%) of the air flows into the aircraft propulsion system 20 and its engine core 80. For example, an outer stream of the air propelled by the rotating propulsor rotor 34 flows axially across the guide vane structure 36 and outside of the housing structure 58 and its exterior surface 60; e.g., along an exterior of the nacelle 106. The guide vane structure 36 conditions (e.g., straightens out, de-swirls, etc.) the outer stream of air within the external environment 22 to enhance the forward thrust. By contrast, an inner stream of the air propelled by the rotating propulsor rotor 34 may bypass the guide vane structure 36 and enter the turbine engine 32 and its engine flowpath 74 through the flowpath inlet 76.

Briefly, the air propelled by the propulsor rotor 34 may be split into the outer air stream and the inner air stream by a splitter 120; e.g., an annular eagle beak structure. A leading edge 122 of the splitter 120 of FIG. 1 forms a radial outer side of the flowpath inlet 76, and may be axially aligned with and may be radially opposite the downstream boundary end. An outer exterior wall 124 of this splitter 120 may extend axially along the propulsion system axis 24 from the splitter leading edge 122 to (or about) the guide vane structure 36. The splitter 120 of FIG. 1 and its splitter exterior wall 124 may thereby form a portion of the exterior surface 60 between the splitter leading edge 122 and the guide vane structure 36.

The air entering the engine flowpath 74 through the flowpath inlet 76 may be referred to as “core air”. This core air is compressed by the LPC rotor 82 and the HPC rotor 83 and directed into a combustion chamber 126 (e.g., an annular combustion chamber) of a combustor 128 (e.g., an annular combustor) in the combustor section 70. Fuel is injected into the combustion chamber 126 by one or more fuel injectors 130 and mixed with the compressed core air to provide a fuel-air mixture. This fuel-air mixture is ignited and combustion products thereof flow through and sequentially drive rotation of the HPT rotor 84 and the LPT rotor 85. The rotation of the HPT rotor 84 and the LPT rotor 85 respectively drive rotation of the HPC rotor 83 and the LPC rotor 82 and, thus, compression of the core air. The rotation of the LPT rotor 85 also drives the rotation of the propulsor rotor 34 through the drivetrain 100 and its geartrain 102. The turbine engine 32 and its low speed rotating structure 98 thereby power operation of (e.g., drive rotation of) the propulsor rotor 34 during the aircraft propulsion system operation.

During the foregoing aircraft propulsion system operation and during aircraft flight, various members of the aircraft propulsion system 20 may generate sound; e.g., noise. The sound may be actively generated by one or more of the propulsion system members. For example, the above-described operation of the turbine engine 32 and rotation of the propulsor rotor 34 may collectively generate a relatively large portion of the sound. The sound may also be passively generated by one or more of the propulsion system members. For example, impingement of air against and/or the flow of the air along various non-rotating members of the aircraft propulsion system 20 may also generate a smaller portion of the sound. Examples of these non-rotating aircraft propulsion system members include, but are not limited to, the housing structure 58 and the guide vane structure 36 and its guide vanes 54. To reduce, suppress, eliminate and/or otherwise attenuate one or more frequencies of sound waves generated during the aircraft propulsion system operation and the aircraft flight, one or more components of the aircraft propulsion system 20 may be configured with acoustic treatment 132A-F (generally referred to as “132”). These acoustically treated aircraft propulsion system components may include any one or more of the following:

the nose cone 38;

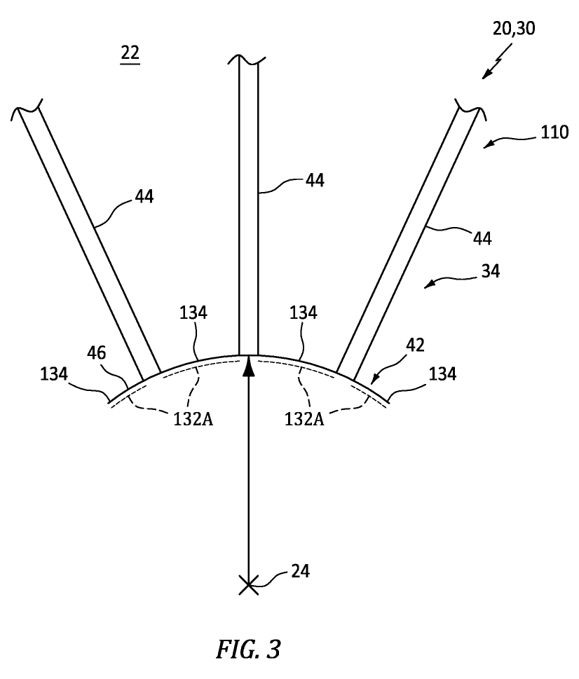

the outer platform 42 of the propulsor rotor 34 and, more particularly, circumferential segments 134 of the outer platform 42 between each circumferential neighboring (e.g., adjacent) pair of the propulsor blades 44 (see FIG. 3);

one or more of the propulsor blades 44, particularly at sides (e.g., pressure and/or suction sides) of the respective propulsor blade(s) 44 for example;

the outer boundary wall 116 axially between the propulsor rotor 34 and the flowpath inlet 76;

the inner flowpath wall 118 forming the inner peripheral boundary of the engine flowpath 74 at least at the flowpath inlet 76; and/or

an outer flowpath wall 136 forming a radial outer peripheral boundary of the engine flowpath 74 at least at the flowpath inlet 76.

The present disclosure, however, is not limited to the foregoing exemplary acoustically treated aircraft propulsion system components. Various other components of the aircraft propulsion system 20 with surfaces that border the external environment 22 and/or surfaces which border a flowpath (e.g., the engine flowpath 74) at an interface (e.g., inlet or outlet) with the external environment 22 may also or alternatively be configured with the acoustic treatment 132.

The aircraft propulsion system component(s) configured with the acoustic treatment 132 may be selected such that the acoustic treatment 132 partially or completely axially, circumferentially, radially and/or otherwise covers one or more regions of the aircraft propulsion system 20. These regions may include any one or more of the following:

a region axially forward and/or upstream of the propulsor rotor 34 (e.g., between the propulsion system forward end 26 and the propulsor rotor 34);

a region axially aligned with and/or otherwise axially overlapping (e.g., extending axially along) the propulsor rotor 34 and its members 42 and 44;

a region axially between the propulsor rotor 34 and the flowpath inlet 76; and/or

a region projecting into an interior of the aircraft propulsion system 20 from the flowpath inlet 76.

One or more select areas or an entirety of the propulsion system flow boundary 110, one or more select areas of an entirety of each propulsor blade 44 and/or an inlet section of the engine flowpath 74 may thereby be acoustically treated with the acoustic treatment 132 to attenuate the sound generated by the operation of the aircraft propulsion system 20. The present disclosure, however, is not limited to the foregoing exemplary acoustically treated aircraft propulsion system region, nor the foregoing exemplary division of the aircraft propulsion system 20 into regions.

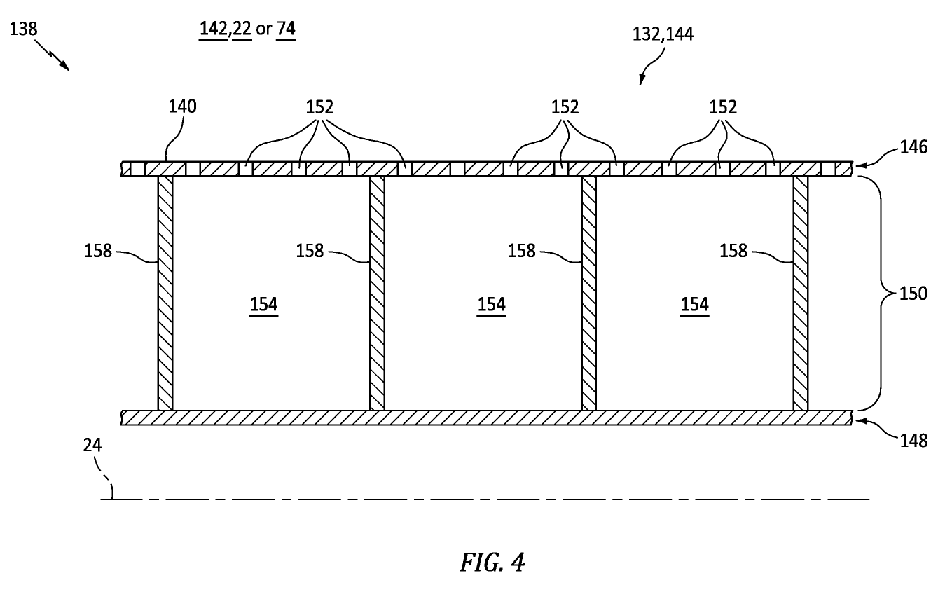

FIG. 4 illustrates a portion of an exemplary aircraft propulsion system component 138 configured with the acoustic treatment 132, which aircraft propulsion system component 138 may be any one of the acoustically treated aircraft propulsion system components described herein. The acoustic treatment 132 extends along a surface 140 (e.g., an exterior surface, a flowpath surface, etc.) of the aircraft propulsion system component 138 that is exposed an open volume 142 through which the sound to be attenuated propagates; e.g., the external environment 22, the engine flowpath 74, etc. The acoustic treatment 132 may be integrated with the aircraft propulsion system component 138. The acoustic treatment 132, for example, may be included as a part of the aircraft propulsion system component 138. Alternatively, the aircraft propulsion system component 138 may be included as a part of (e.g., configured as a skin of) the acoustic treatment 132.

The acoustic treatment 132 is configured to reduce, suppress, eliminate and/or otherwise attenuate one or more frequencies of the sound waves propagating through the open volume 142 along the component surface 140. The acoustic treatment 132 of FIG. 4, for example, is configured as a cellular acoustic structure 144; e.g., an acoustic panel. This acoustic structure 144 of FIG. 4 includes a fluid permeable (e.g., perforated) face skin 146, a fluid impermeable (e.g., non-perforated) back skin 148 and a cellular core 150.

The face skin 146 is configured as an exterior skin of the aircraft propulsion system component 138 which forms the component surface 140 and borders the open volume 142. The face skin 146 includes a plurality of perforations 152; e.g., apertures such as through-holes. Each of these face skin perforations 152 extends laterally through a thickness of the face skin 146.

The back skin 148 may be configured as a continuous, uninterrupted and/or non-porous skin. The back skin 148 of FIG. 4, for example, is configured without any perforations at least aligned with the cellular core 150.

The cellular core 150 is arranged laterally between the face skin 146 and the back skin 148. The cellular core 150 of FIG. 4, for example, extends laterally from an interior side of the face skin 146 to an interior side of the back skin 148. The cellular core 150 may also be connected to (e.g., formed integral with or attached to) the face skin 146 and/or the back skin 148.

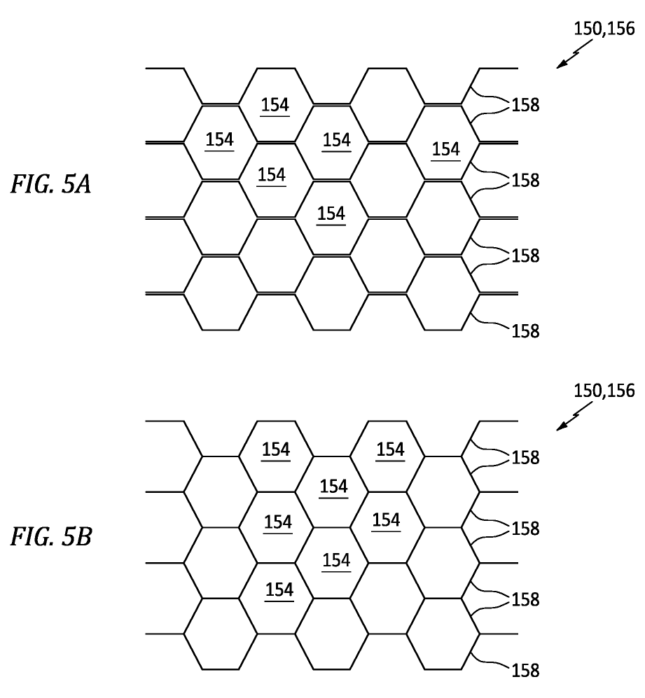

The cellular core 150 forms one or more internal chambers 154 (e.g., acoustic resonance chambers, cavities, etc.) laterally between the face skin 146 and the back skin 148. The cellular core 150 of FIG. 5A, for example, includes a cellular core structure 156 with a plurality of corrugated sidewalls 158. These corrugated sidewalls 158 are arranged in a side-by-side array and are connected to one another such that each neighboring pair of the corrugated sidewalls 158 forms an array of the internal chambers 154 (e.g., spanwise and/or longitudinally) therebetween. While the corrugated sidewalls 158 may be discrete elements, some or all of the corrugated sidewalls 158 may alternatively be formed integral with one another as shown in FIG. 5B. Such an integral sidewall structure may be formed using machining, additive manufacturing and/or other manufacturing processes.

Each of the internal chambers 154 of FIG. 4 extends laterally within / through the cellular core 150 between and to the face skin 146 and the back skin 148. One or more of all of the internal chambers 154 may thereby each be fluidly coupled with a respective set of one or more of the face skin perforations 152.

Each of the internal chambers 154 has a first chamber sectional geometry (e.g., shape, size, etc.) when viewed in a first reference plane; e.g., the plane of FIG. 4. This first chamber sectional geometry may have a polygonal shape; e.g., a rectangular shape. Referring to FIGS. 5A and 5B, each of the internal chambers 154 has a second chamber sectional geometry (e.g., shape, size, etc.) when viewed in a second reference plane; e.g., the plane of FIG. 5A, 5B. This second chamber sectional geometry may have a polygonal shape; e.g., a hexagonal shape. With such a configuration, the cellular core structure 156 may be a honeycomb core. The present disclosure, however, is not limited to foregoing exemplary cellular core configuration. For example, one or more or all of the internal chambers 154 may each alternatively have a circular, elliptical or other non-polygonal cross-sectional geometry. Furthermore, various other types of honeycomb cores and, more generally, various other types of cellular cores for acoustic structures are known in the art, and the present disclosure is not limited to any particular ones thereof.

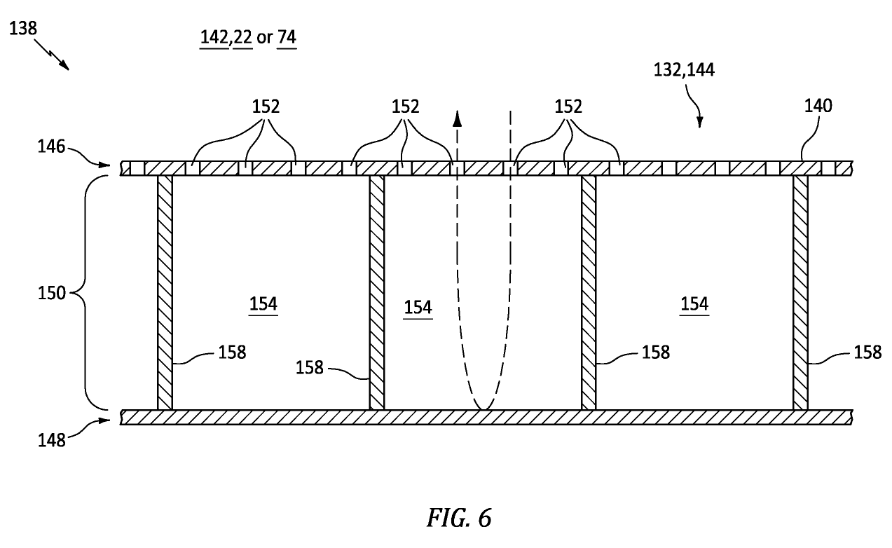

Referring to FIG. 6, the acoustic structure 144 may be configured as a single-degree of freedom (SDOF) acoustic structure. Sound waves propagating within the open volume 142, for example, may enter the aircraft propulsion system component 138 and its associated acoustic structure 144 through the face skin perforations 152. Within the acoustic structure 144, the sound waves may travel through a respective one of the internal chambers 154 and reflect against, for example, the back skin 148. These reflected sound waves may travel back through the respective internal chamber 154 and exit the aircraft propulsion system component 138 and its associated acoustic structure 144 through the respective face skin perforation(s) 152, where those reflected sound waves may be out of phase from and destructively interfere with incoming sound waves. Of course, the sound waves may also or alternatively reflect against one or more other elements of the acoustic structure 144 which may further influence sound attenuation.

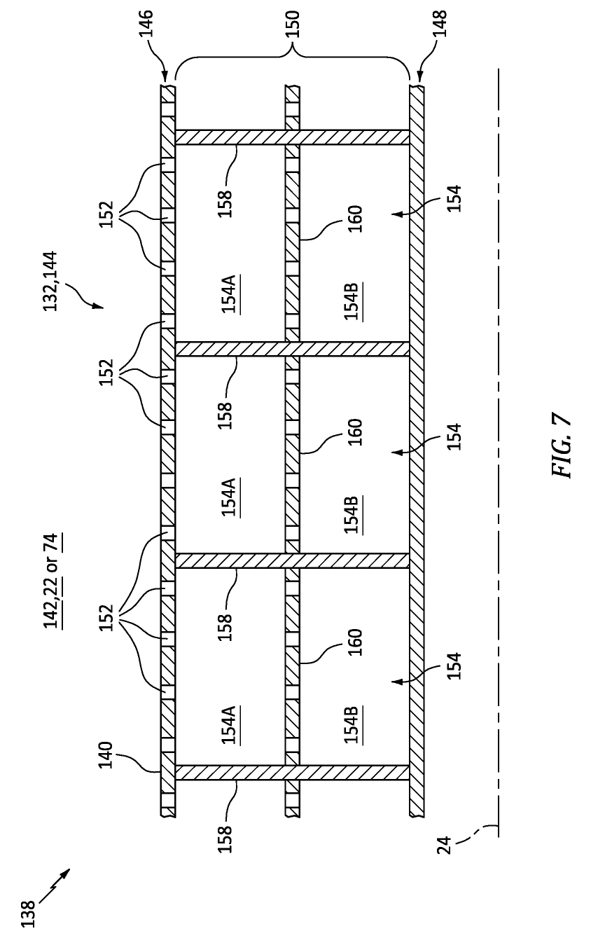

While the acoustic structure 144 is described above as a single-degree of freedom (SDOF) acoustic structure, the present disclosure is not limited thereto. For example, referring to FIG. 7, the acoustic structure 144 may alternatively be configured as a multi-degree of freedom (MDOF) acoustic structure; e.g., a double-degree of freedom (DDOF) acoustic structure. One or more or all of the internal chambers 154 of FIG. 7, for example, may each be provided with at least one fluid-permeable (e.g., perforated) septum 160 to divide that respective internal chamber 154 into a set of fluidly coupled sub-chambers 154A and 154B. Moreover, while each internal chamber 154 or sub-chamber 154A, 154B is shown in FIGS. 4, 6 and 7 as an open space (e.g., a volume unoccupied by another element), it is contemplated one or more of the internal chambers 154 or sub-chamber 154A, 154B may alternatively be partially or completely filled with a porous material such as foam and/or felt.

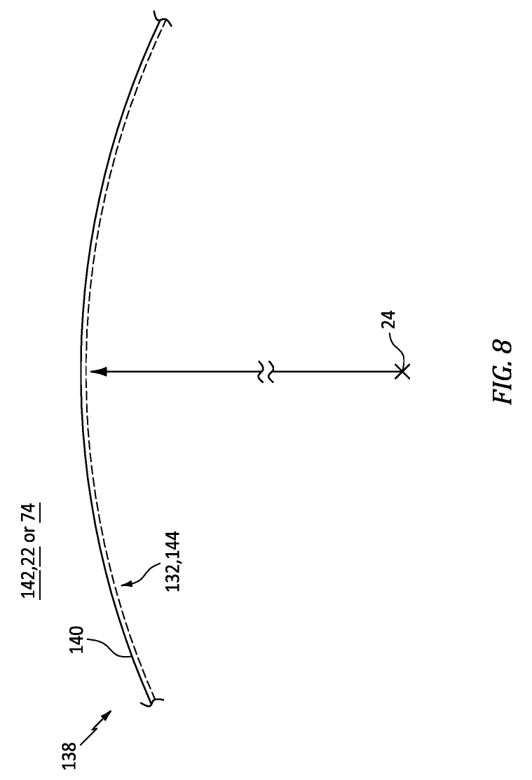

Referring to FIG. 4, where the aircraft propulsion system component 138 is configured as one of the acoustically treated aircraft propulsion system components (e.g., 38, 42, 44, 116, 118 and/or 136) of FIG. 1, the acoustic structure 144 / the acoustic treatment 132 may extend axially along the propulsion system axis 24 and the component surface 140 thereby partially or completely covering an axial extent of the aircraft propulsion system component 138 and its component surface 140. Referring to FIG. 8, where the aircraft propulsion system component 138 is configured as one of the acoustically treated aircraft propulsion system components (e.g., 38, 42, 116, 118 and/or 136) of FIG. 1, the acoustic structure 144 / the acoustic treatment 132 may extend circumferentially about (e.g., partially or completely around) the propulsion system axis 24 and along the component surface 140 thereby partially or completely covering a circumferential extent of the aircraft propulsion system component 138 and its component surface 140. For example, referring to FIG. 3, each outer platform segment 134 of the propulsor rotor 34 may be partially or completely acoustically treated circumferentially between and axially along a respective circumferentially neighboring pair of the propulsor blades 44. Where the aircraft propulsion system component 138 is configured as one of the acoustically treated propulsor blades 44 of FIG. 1, the acoustic structure 144 / the acoustic treatment 132 (see FIG. 5) may extend radial along the component surface 140 (see FIG. 5) thereby partially or completely covering a radial extent of the aircraft propulsion system component 138 and its component surface 140.

The aircraft propulsion system 20 of FIG. 1 and its propulsion section 30 are described above with a tractor configuration; e.g., where the propulsor rotor 34 is disposed at or otherwise near the propulsion system forward end 26. It is contemplated, however, the propulsion section 30 may alternatively be disposed at or otherwise near the propulsion system aft end 28 to provide a pusher fan configuration.

The guide vane structure 36 is described above as a fixed (e.g., non-rotatable) guide vane structure. It is contemplated, however, the guide vane structure 36 may alternatively be selectively rotatable about the propulsion system axis 24. With such an arrangement, the aircraft propulsion system 20 may be configured as an open rotor propulsion system with a swirl recovery blade (SRB) open rotor architecture. More particularly, the aircraft propulsion system 20 may operate as: (A) a counter-rotating open rotor (CROR) propulsion system during a dual rotor mode of operation (e.g., when both the propulsor rotor 34 and the structure 36 are counter-rotating about the propulsion system axis 24); and (B) a single open rotor and swirl recovery vane (SRV) propulsion system during a single rotor mode of operation (e.g., when the propulsor rotor 34 is rotating and the structure 36 is rotationally fixed about the propulsion system axis 24). Note, when the guide vane structure 36 is configured to selectively rotate about the propulsion system axis 24, the moving guide vanes 54 operate as propulsor blades.

The aircraft propulsion system 20 of FIG. 1 and its propulsion section 30 are described as including the guide vane structure 36 with an SRV or SRB configuration. The present disclosure, however, is not limited to such an exemplary propulsion system configuration. For example, the aircraft propulsion system 20 may alternatively be configured without an open guide vane structure. The aircraft propulsion system 20 may thereby be configured as a single rotor (SR) open rotor propulsion system. In another example, the aircraft propulsion system 20 may alternatively be configured with a set of the open propulsor rotors (e.g., counter-rotating propulsor rotors) operatively coupled to the turbine engine 32 (see FIG. 1) through the geartrain 102. The aircraft propulsion system 20 may thereby be configured as a counter-rotating open rotor (CROR) propulsion system.

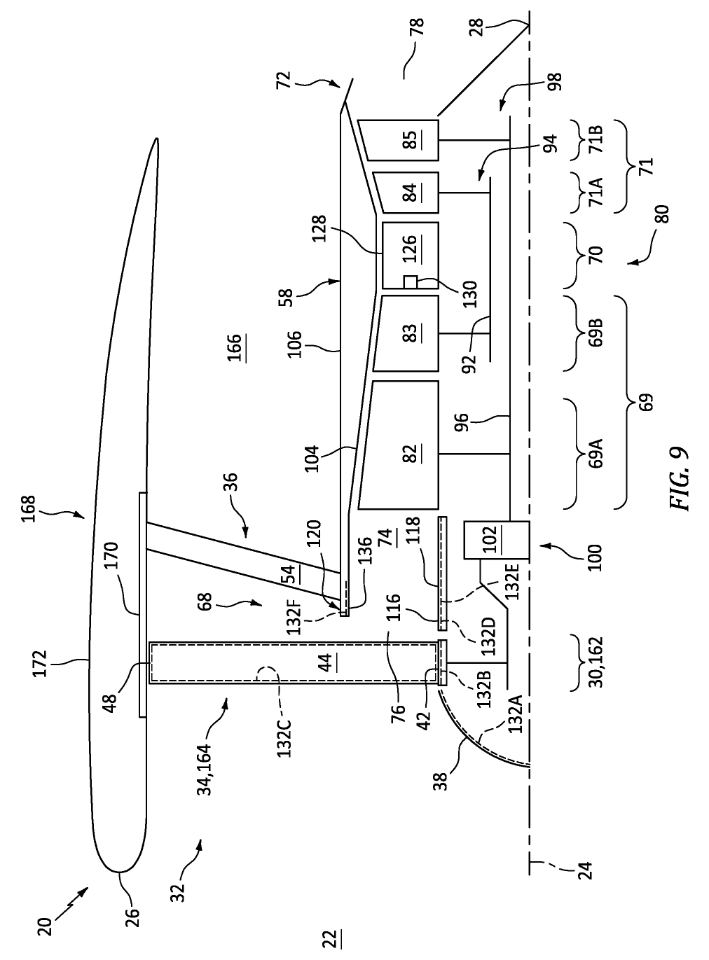

While the aircraft propulsion system 20 is described above with various exemplary open rotor propulsion system configurations, the present disclosure is not limited thereto nor to open rotor propulsion system applications. More particularly, the aircraft propulsion system 20 may be configured as any other type of aircraft propulsion system with one or more open and/or ducted propulsor rotors. For example, referring to FIG. 9, the aircraft propulsion system 20 may alternatively be configured as a turbofan propulsion system. With such an arrangement, the propulsion section 30 is configured as a fan section 162 of the turbine engine 32, and the propulsor rotor 34 is configured as a ducted fan rotor 164 in the turbine engine fan section 162.

The housing structure 58 of FIG. 9 is configured as, and therefore referred to below as, an inner housing structure for the aircraft propulsion system 20. This inner housing structure 58 may house the engine core 80 and at least part of the drivetrain 100 as described above. However, whereas the housing structure 58 of FIG. 1 and its nacelle 106 are exposed to the external environment 22, the inner housing structure 58 of FIG. 9 and its nacelle 106 (here, an inner nacelle structure for the aircraft propulsion system 20 such as an inner fixed structure (IFS)) form a radial inner peripheral boundary of a bypass flowpath 166 (e.g., an annular bypass flowpath) within the aircraft propulsion system 20. This bypass flowpath 166 is configured to bypass (e.g., is disposed radially outboard of and extends along) the engine core 80 and the inner housing structure 58.

An outer housing structure 168 of the aircraft propulsion system 20 of FIG. 9 includes an outer case 170 (e.g., a fan case) for the turbine engine 32 and an outer nacelle structure 172 for the aircraft propulsion system 20. The outer case 170 is disposed radially outboard of, extends axially along and may circumscribe the fan section 162 and its fan rotor 164. The outer case 170 may thereby house and provide a containment structure for the fan section 162 and its fan rotor 164. The outer nacelle structure 172 is configured to provide an aerodynamic cover over the outer case 170. The outer housing structure 168 and its outer nacelle structure 172 may also form a radial outer peripheral boundary of the bypass flowpath 166. With this arrangement, the outer housing structure 168 is spaced radially outboard from the inner housing structure 58. The outer housing structure 168 and its members 170 and 172 also extend axially along (e.g., axially overlap) and extend circumferentially about (e.g., circumscribe) the inner housing structure 58 and the engine core 80.

The guide vane structure 36 of FIG. 9 is configured within the bypass flowpath 166. More particularly, each guide vane 54 extends radially across the bypass flowpath 166 from the inner housing structure 58 to the outer housing structure 168. Each guide vane 54 is also connected to the inner housing structure 58 and the outer housing structure 168. With this arrangement, the guide vanes 54 of FIG. 9 are configured as ducted fan exit guide vanes.

In some embodiments, referring to FIGS. 1 and 9, the engine flowpath 74 may extend longitudinally from the flowpath inlet 76, sequentially through the inlet section 68, the LPC section 69A, the HPC section 69B, the combustor section 70, the HPT section 71A, the LPT section 71B and the exhaust section 72, to the flowpath exhaust 78. The engine flowpath 74 of FIGS. 1 and 9 is configured such that the core air and the combustion products generally flow in the aft, downstream direction towards the propulsion system aft end 28. The core air and the combustion products thereby flow along with the ambient air / bypass air propelled by the rotating propulsor rotor 34 in a common axial direction – the downstream, aft direction. The turbine engine 32 of the present disclosure, however, is not limited to such an exemplary common flow engine arrangement. For example, the engine flowpath 74 may alternatively be configured such that the core air and the combustion products generally flow in a forward, upstream direction towards the propulsion system forward end 26. The core air and the combustion products may thereby flow in an opposite direction as the ambient air / the bypass air propelled by the rotating propulsor rotor 34. Here, the turbine engine 32 may have a reverse flow engine arrangement.

While the turbine engine 32 is described above and shown in FIGS. 1 and 9 with a particular two rotating structure (e.g., two spool) arrangement, the present disclosure is not limited thereto. For example, the LPC rotor 82 may be omitted to configure the LPT rotor 85 as a power turbine (PT) rotor for the propulsor rotor 34. In another example, the turbine engine 32 may also include another rotating structure; e.g., an intermediate speed spool for the engine core 80.

While various embodiments of the present disclosure have been described, it will be apparent to those of ordinary skill in the art that many more embodiments and implementations are possible within the scope of the disclosure. For example, the present disclosure as described herein includes several aspects and embodiments that include particular features. Although these features may be described individually, it is within the scope of the present disclosure that some or all of these features may be combined with any one of the aspects and remain within the scope of the disclosure. Accordingly, the present disclosure is not to be restricted except in light of the attached claims and their equivalents.

What is claimed is:

1. An apparatus for an aircraft, comprising:
a propulsion system including a propulsor rotor and an engine core configured to power rotation of the propulsor rotor about an axis;
the propulsor rotor including a plurality of propulsor blades and an outer platform, the plurality of propulsor blades arranged circumferentially about the axis, each of the plurality of propulsor blades projecting radially out from the outer platform to a respective propulsor blade tip, and the outer platform configured with a platform acoustic treatment; and
the engine core including a flowpath, a compressor section, a combustor section and a turbine section, and the flowpath extending through the compressor section, the combustor section and the turbine section.

2. The apparatus of claim 1, wherein at least a portion of the platform acoustic treatment is disposed between a circumferentially neighboring pair of the plurality of propulsor blades.

3. The apparatus of claim 1, wherein at least a portion of the platform acoustic treatment extends circumferentially about the axis between and axially along the axis next to a circumferentially neighboring pair of the plurality of propulsor blades.

4. The apparatus of claim 1, wherein
the propulsion system further includes a nose cone axially next to the propulsor rotor; and
the nose cone is configured with a nose cone acoustic treatment.

5. The apparatus of claim 4, wherein the nose cone is configured to rotate with the propulsor rotor about the axis.

6. The apparatus of claim 1, wherein a wall of the propulsion system extends axially between the propulsor rotor and an inlet into the flowpath, and the wall is configured with a wall acoustic treatment.

7. The apparatus of claim 1, wherein a first of the plurality of propulsor blades is configured with a blade acoustic treatment.

8. The apparatus of claim 1, wherein the propulsion system further includes an engine case housing the propulsor rotor.

9. The apparatus of claim 1, wherein
the propulsor rotor is an open propulsor rotor; and
the outer platform is exposed to and borders an environment external to the propulsion system.

10. The apparatus of claim 1, wherein the platform acoustic treatment comprises an acoustic panel with a cellular core.

11. The apparatus of claim 1, wherein the platform acoustic treatment comprises a single degree-of-freedom acoustic treatment.

12. The apparatus of claim 1, wherein the platform acoustic treatment comprises a multi degree-of-freedom acoustic treatment.

13. An apparatus for an aircraft, comprising:
a propulsion system including a propulsor rotating structure and an engine core configured to power rotation of the propulsor rotating structure about an axis;
the propulsor rotating structure comprising a propulsor rotor, and the propulsor rotor comprising a plurality of propulsor blades arranged circumferentially about the axis; and
the engine core including a flowpath, a compressor section, a combustor section and a turbine section, and the flowpath extending through the compressor section, the combustor section and the turbine section from an inlet into the flowpath to an exhaust from the flowpath;
wherein a flow boundary of the propulsion system is acoustically treated to attenuate sound generated by operation of the propulsion system along at least
an upstream section of the flow boundary that is upstream of the plurality of propulsor blades; and
a downstream section of the flow boundary that is downstream of the plurality of propulsor blades and upstream of the inlet into the flowpath.

14. The apparatus of claim 13, wherein at least one of
the propulsor rotating structure further comprises a nose cone, and the nose cone at least partially forms the upstream section of the flow boundary; or
the propulsion system further includes an outer boundary wall axially between the propulsor rotor and the inlet into the flowpath, and the outer boundary wall at least partially forms the downstream section of the flow boundary.

15. The apparatus of claim 13, wherein an outer platform of the propulsor rotor is further acoustically treated to attenuate the sound generated by the operation of the propulsion system.

16. An apparatus for an aircraft, comprising:
an open rotor propulsion system comprising a propulsor rotating structure and a turbine engine configured to drive rotation of the propulsor rotating structure about an axis;
the propulsor rotating structure comprising an open propulsor rotor;
wherein an exterior surface of a component of the propulsor rotating structure is exposed to and borders an environment external to the open rotor propulsion system, and the component is configured with a component acoustic treatment extending axially and circumferentially along the exterior surface.

17. The apparatus of claim 16, wherein the component comprises an outer platform of the open propulsor rotor.

18. The apparatus of claim 16, wherein the propulsor rotating structure further comprises a nose cone, and the component comprises the nose cone.

19. The apparatus of claim 16, wherein an outer boundary wall extending axially between the open propulsor rotor and an inlet into the turbine engine is configured with a wall acoustic treatment.

20. The apparatus of claim 16, wherein the open propulsor rotor comprises a plurality of open propulsor blades arranged circumferentially about the axis, and a first of the plurality of open propulsor blades is configured with a blade acoustic treatment.
